(19) United States
(12) Patent Application Publication
(10) Pub. No.: US 2009/0307024 A1
(43) Pub. Date: Dec. 10, 2009

(54) SYSTEM AND METHOD FOR PRESENTING INFORMATION ABOUT CONSERVATION ACTIVITIES OF AN ORGANIZATION

(76) Inventors: Yorgen Edholm, Palo Alto, CA (US); Nikhil Jhingan, Singapore (SG); Paula Skokowski, Palo Alto, CA (US); Vinod Vasnani, Singapore (SG)

Correspondence Address: MAHAMEDI PARADICE KREISMAN LLP, 4880 STEVENS CREEK BOULEVARD, SUITE 201, SAN JOSE, CA, 95129-1034, US

(21) Appl. No.: 12/135,082

(22) Filed: Jun. 6, 2008

(51) Int. Cl. G06Q 10/00; G06Q 50/00

(52) U.S. Cl. 705/7

(57) ABSTRACT

A system is provided for presenting information about waste reduction or resource preservation activities of one or more entities. The system may include at least one server resource that is programmed to generate a presentation for an online medium. The presentation may provide at least a first information item that is indicative of a determination of a reduction by a given entity in either of an identified waste byproduct or a resource consumption. The reduction is a result of one or more kinds of a conservation activity that is performed by one or more individuals in the organization.

### BACKGROUND

The manner and extent to which technology has innovated and advanced the corporate environment have evolved rapidly. Among areas of rapid advancements, sharing information in the enterprise environment has evolved greatly, with developments in messaging and streaming communications. For example, technology for enabling electronic document transfers has increasingly become more sophisticated and ‘IT friendly’, with use of electronic file transfer services, such as provided by ACCELLION, INC. Other examples of advancements in information sharing include video-conferencing and desktop sharing.

Corporate governance and marketing is also increasingly becoming more aware of environmental concerns. Corporations increasingly recycle and rely on environmentally-friendly resources. Many organizations also employ ‘green’ officers or employees, who monitor, market and/or promote the corporation's efforts at being ‘green’. One important area of environmental concern is global warming. Under some of the leading theories as to the cause of global warming (or related environmental affects, such as severe weather), global warming is attributable at least in part to the emissions of greenhouse gases. The increase in carbon dioxide emissions, in particular, is considered one of the human-attributable causes of global warming. There is considerable effort to reduce emissions of carbon dioxide and other greenhouse gases by reducing activities such as transportation (whether by car or airplane) and increasing conservation activities to reduce expenditure of scarce resources, such as fossilized fuels.

### BRIEF DESCRIPTION OF THE DRAWINGS

FIG. 1 provides an overview of a system for presenting information about an organization's waste reduction or resource preservation activities, according to one or more embodiments.

FIG. 2 illustrates a system architecture for enabling calculation and display of information that indicates an organization's conservation activities, according to an embodiment of the invention.

FIG. 3 illustrates a machine architecture for use with one or more embodiments described herein.

FIG. 4 illustrates a method by which an activity involving electronic communications may be correlated to reduction of environmental concerns, under an embodiment.

FIG. 5 illustrates a method for determining and presenting information that quantifies an environmental concern as a result of the organization using electronic communications to perform a class of activities, under an embodiment of the invention.

FIG. 6 illustrates a presentation that may be generated or configured, according to one or more embodiments described herein.

### DETAILED DESCRIPTION

Embodiments described herein enable persons or organizations, including corporations or other enterprises, to recognize their usage of technology as having an identifiable environmental benefit, such as reduction of carbon dioxide emissions. In some embodiments, organizations may promote and advertise their activities involving specific forms of electronic communication as being ‘eco-friendly’. In particular, embodiments described herein enable an organization to publicize activities or services that have secondary benefits to environmental concerns, such as global warming. These activities may involve the organization electing to use electronic communication technology to achieve a desired result, when a comparable result could have been achieved through use of less eco-friendly means that involve physical transportation.

According to an embodiment, specific activities performed using electronic communications may be compared against conventional counterparts to quantify a benefit to a particular environmental concern. For example, a corporation's use of an electronic file transfer service to transmit documents to recipients may be compared against a comparable result that could be attained if the corporation elects to ship hard copies of the same documents to the recipients. In such an implementation, an embodiment may calculate (i) benefit reduction of carbon dioxide or other greenhouse gases as a result of the organization foregoing physical transfer (e.g. fuel required to ship by courier), or (ii) packages or envelopes conserved as a result of the use of electronic transfer (rather than physical file transfer).

According to an embodiment, a computer-implemented method is provided for presenting information about an organization's waste reduction or resource preservation activities. In an embodiment, data is recorded corresponding to one or more instances in which the organization elects to forego use of physical transportation in favor of using electronic communications. The instances in which the organization achieves a desired result through electronic communications, rather than physical transport, are then recorded. A determination is programmatically made that quantifies a benefit to an environmental concern. In an embodiment, this may correspond to a determination of a quantity of a resource that is conserved by the organization electing to use the electronic communications.

According to an embodiment, a presentation is generated on an electronic medium that includes information which indicates or is derived from the quantification of the benefit to the environmental concern. In one implementation, this determination may represent the quantity of a resource that is being conserved as a result of the organization's decision to use electronic communications. As described elsewhere, the information provided on the presentation may include information items that tally resources conserved and/or calculate on an ongoing basis more complex determinations of environmental benefits (e.g. reduction in greenhouse gases).

Still further, an embodiment provides for use of baseline data that correlates each instance that the organization elects to forego the use of physical transportation in favor of electronic communications, with data that quantifies a resource or other environmental concern that would be expended had physical transportation been used. The quantified data may represent, for example, an amount of a conserved resource or waste reduction, attributable to the non-use of physical transportation. Instances may be recorded in which the organization elects to electronically transfer information as an alternative to physically transporting a corresponding item that carries the information on an alternative medium. Based at least in part on the baseline data, a determination may be made of the value that represents at least one of the resource preserved or the waste reduced as a result of the organization electing to electronically transfer information at the recorded instances. Data may be generated that is to be used as part of a presentation for an electronic medium. The data may indicate or be presented as information items that reflect the value of the resource preservation/waste reduction.

One or more embodiments include a system, comprising components that collectively combine to perform some or all of steps described above or elsewhere in this application.

In another embodiment, a computer-generated presentation is provided over an online medium. The computer-generated presentation may include a first information item that is indicative of a determination of the organization's reduction in an identified waste byproduct or resource consumption, as a result of one or more kinds of conservation activities that the organization promotes or enables by an individual or individuals within the organization.

In another embodiment, a system is provided for presenting information about waste reduction or resource preservation activities of one or more entities. The system may include at least one server resource that is programmed to generate a presentation for an online medium. The presentation may provide at least a first information item that is indicative of a determination of a reduction by a given entity in either of an identified waste byproduct or a resource consumption. In an embodiment, the reduction is a result of one or more kinds of a conservation activity that is performed by one or more individuals in the organization.

As used herein, an “organization” may refer to a legal or formal organization, such as a corporation, non-profit organization, or partnership, as well as an information organization, such as a community of persons that share common resources.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

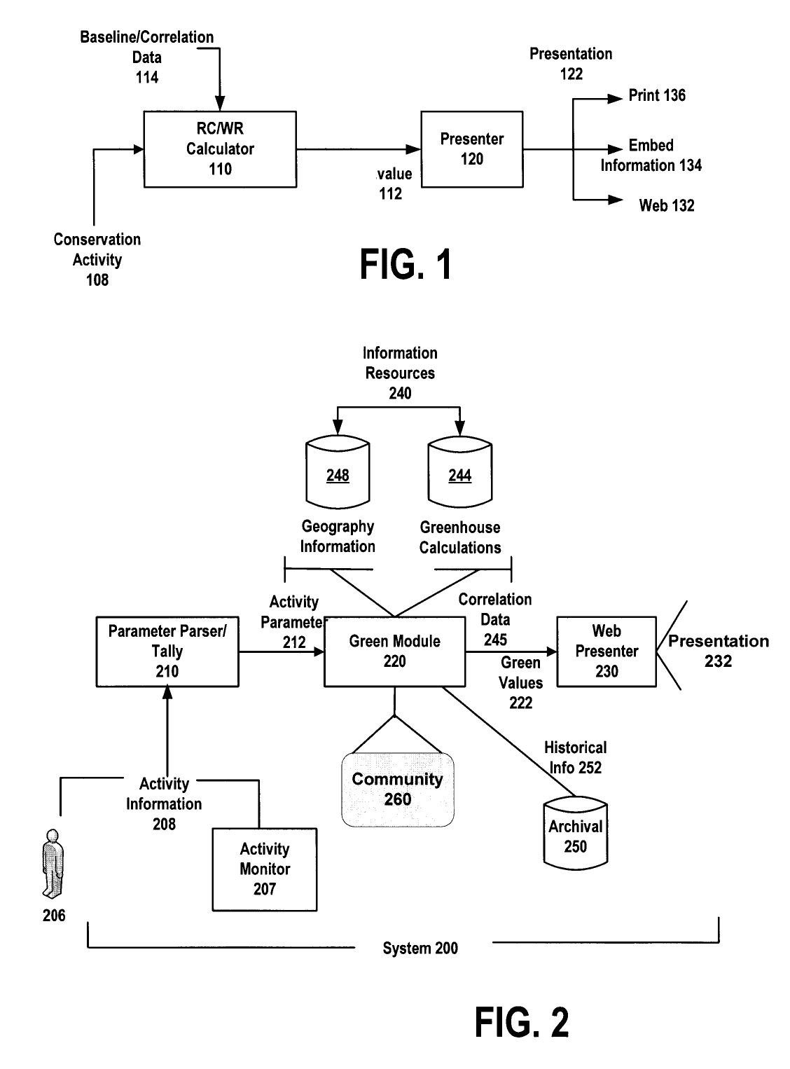

Any of the embodiments described with FIG. 1 may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, any embodiments described herein may be implemented through the use of instructions that are executable by one or more processors. These instructions may be carried on a computer-readable medium. Machines or modules shown in figures provide herein include examples of processing resources and computer-readable mediums on which instructions for implementing embodiments of the invention can be carried and/or executed. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Overview

FIG. 1 provides an overview of a system for presenting information about an organization's waste reduction or resource preservation activities, according to one or more embodiments. A system such as described with an embodiment of FIG. 1 may quantify or otherwise evaluate an organization's conservation activities based on a predetermined objective measure. The results of the quantification or evaluation may then be presented for the public or for interested third parties. Numerous types of conservation activities may be accounted for in quantifying the conservation activities of the organization. In determining quantification/evaluation to present, each instance of the conservation activity may be compared to a hypothetical environmental cost that would otherwise occur if the corporation had elected to achieve a comparable result through performance of a conventional and environmentally unfriendly course of action. In an embodiment, conservation activities include or correspond to the organization's use of electronic communications to replace traditional activities that would otherwise require physical transport.

In particular, one embodiment corresponds or includes instances in which the organization elects to forego a shipment or transportation event, in favor achieving a comparable result through use of electronic communications. For example, an organization may elect to use electronic file transfer in place of using couriers to physically deliver corresponding documents. As another example, an organization may elect to conduct a virtual conference or meeting of persons that would otherwise travel or commute to meet in person. With regard to the file transfer example, the conservation activity may correspond to the organization using an electronic file delivery service to ‘deliver’ documents by, for example, electronic mail, where the document delivery process may require confirmation that the documents were received or viewed, or even acknowledgment from the recipient of the delivery. In such a scenario, an electronic document delivery systems may be used in lieu of, for example, traditional ‘hard copy’ delivery of the documents via a courier or postal service. Numerous other kinds of conservation activities may be accounted for with embodiments described herein.

Accordingly, an embodiment provides that system 100 include processes, that when executed, provide functionality that correspond to a resource conservation/waste reduction calculator 110 (‘calculator 110’) and a presentation component 120. The calculator 110 performs operations that include (i) identifying instances that a conservation activity 108 occurred, and (ii) generating one or more values 112 that quantify a pre-determined environmental benefit. Data input, corresponding to conservation activity 108, may be used to determine the value 112. The conservation activity 108 may correspond to acts by the organization (including acts performed by persons that work for or on behalf of the organization) that satisfy a pre-defined criteria or definition for constituting an instance of the conservation activity. The conservation activity 108 may be identified manually, programmatically, or through a combination of manual input and programmatic determination. In one or more embodiments, the conservation activity 108 is an act that is performed using electronic communications as a replacement or substitution for an alternative act that would require transportation of documents, information items, persons or other things.

The value 112 may quantify benefits to environmental concerns, such as conservation or global warming concerns. In an embodiment, the value 112 may correspond to or include a tally of all the identified instances of conservation activity. As an alternative or addition, the value 112 may also weight or account for descriptive information that is identified or learned in connection with performance of each identified instance. The descriptive information may weight or supplement individual instances that comprise the tally, or alternatively serve to formulate the component of the value 112 attributable to the individual instance.

In one embodiment, an operator may enter information that identifies and/or provides description of the conservation activity 108. In another embodiment, a programmatic element, such as provided by software and/or hardware, may monitor activities of the organization to identify instances of the conservation activity 108. What constitutes conservation activity 108 may be pre-defined. Still further, conditions or criteria by which instances in which an activity is to be considered input as conservation activity 108 may be set an objective or pre-determined standard. For example, the standard of when and how instances of an organization's activity are to count as conservation activity 108 may be provided by a party or service other than the organization.

In an implementation in which the conservation activity 108 corresponds to the use of electronic document delivery services in lieu of physical transport or shipment by courier, conservation activity 108 may be determined from an operator entering instances in which an electronic file transfer service (for delivering large files, or certified electronic files) is used. In one embodiment, the use of the electronic file transfer services may be recorded as an instance of a conservation activity when (i) the electronic file transfer communicates a content (e.g. document) to a recipient, (ii) in place of the content being transported on an alternative medium (e.g. CD-Rom or paper) to the same recipient.

Alternatively, an organization's account with the third-party electronic delivery service may be programmatically and/or manually monitored to identify instances of conservation activity 108. Descriptive information that accompanies the input for the conservation activity 108 may also be entered In the case where the electronic file transfer is performed in lieu of physical transport/shipping, the descriptive information may include the information that relates to a physical distance separating the source and destination of the file delivery. For example, the descriptive information may include the address of the source and destination, or the miles separating the source and destination address. As an alternative or addition, the descriptive information may also include shipping costs or resources, such as the number of envelopes or packages that would otherwise be needed to perform the physical transfer of the files.

According to an embodiment, one or more values 112 determined from calculator 110 include measures that requires use of baseline or correlation data 114. The baseline or correlation data 114 may map an instance of a conservation activity to a hypothetical environmental cost that would otherwise be expended if the organization elects to achieve the desired outcome through performance of a conventional or traditional non-environmentally beneficial activity. In an embodiment, calculator 110 uses data corresponding to conservation activity 108 and baseline or correlation data 114 in determining the one or more values 112 as measures of the effectiveness of the organization in reducing an environmental cost (e.g. carbon dioxide emissions). In one implementation, at least one of the values 112 is a measure or quantification of a hypothetical cost in the form of carbon dioxide emissions (or other ‘greenhouse’ gases) that would otherwise be released has the organization attempt a comparable outcome through traditional non-environmental means. In one implementation, the correlation data 114 may identify conserved/reduced quantities of carbon dioxide or greenhouse gases per instance of the conservation activity 108. For example, each shipment of physical documents that is avoided as a result of the organization electing to use electronic file transfer may be correlated to the same averaged quantity of carbon dioxide/greenhouse gas reduction. As an alternative or addition, the baseline or correlation data 114 may be weighted or affected by parameters that account for specific information that is known about a given conservation activity 108. One example is a parameter that is indicative of a geographic separation of the receiving party from the sending party. Thus, in the example provided, the correlation data 114 may approximate the geographic separation of the receiving party from the organization, and use additional metrics to make an estimation of the greenhouse or carbon dioxide gases that would be emitted if the organization elects to ship documents to the receiving party. Correlation data 114 representing greenhouse or carbon dioxide emissions may also be based on courier service shipment method, or information that is based on the courier activity. In the context of reducing carbon dioxide or greenhouse gases, the correlation data 114 attributes a specific value to the avoidance of a comparable physical shipment. Optionally, parameters such as (i) geographic separation between the source and destination for the file transfer delivery, (ii) the type of transport (by ground or by air) that would normally be required for the physical counterpart, or (iii) the courier service used (e.g. FEDERAL EXPRESS) may be accounted for by the correlation data 114. The correlation data 114 thus converts an instance of conservation activity 108 into a quantity representing waste reduction (e.g. Greenhouse gases) or resource conservation. The correlation data may be objective, but representative and not a true measure of the actual waste reduction/resource conservation. For example, in one implementation, the correlation data 114 may be the same value for any electronic file transfer that replaces a physical shipment, without consideration for the geographic separation of the sender or recipient.

In an embodiment, the value 112 may comprise or include more than one value, representing different conserved resources/waste reduction quantities and metrics. For example, one instance of a conservation activity 108 may generate multiple values 112, including (i) one value that is a tally of a resource conserved, without use of correlation data 114 or other baseline information, (ii) another value that is derived or determined from parameters or analysis that include, for example, correlation data 114. For example, when the conservation activity 108 corresponds to an electronic file transfer (in lieu of courier transport of physical items), the value 112 may include (i) reduction in carbon dioxide or greenhouse gases as a result of the organization electing to use electronic file transfer instead of physical shipment, and (ii) tally of package or envelopes conserved. The carbon dioxide reduction may be calculated using correlation data 114 or baseline information.

As an addition or alternative, the correlation data 114 may include formulas, algorithms and/or rules, so as to enable a determinative process.

The values 112 may be used by the presentation component 120 to generate a presentation 122 that is directed to persons or the public. The presentation 122 may represent the organization's conservation activities in terms of a quantity of a conserved resource, reduced waste and/or other environmental benefit. As described elsewhere, specific examples of the type of information that may be displayed with presentation 122 include quantities that represent, as a result of the organization electing to use electronic communications rather than physical transportation, the number of envelopes saved, the amount of fuel or energy conserved, a quantity of raw material conserved, an avoidance of greenhouse gases (such as carbon dioxide) emitted or eliminated. Accordingly, the presentation 122 may carry or convey information that is descriptive of the organization's conservation activities. This information may be quantitative (e.g. count of envelopes or other resources, amount of carbon dioxide emissions reduced in metric tons) or qualitative (‘very green’ or ‘top performer in greenhouse emissions saved’). The information that is presented on the presentation 122 may be updated continuously or repeatedly through a day or other given period.

The presentation 122 may be provided in anyone of many possible forms. The presentation 122 may include web-based presentations 132, embedded information 134, or print presentations 136. Still further, other forms of presentations are contemplated, such as through signage (e.g. billboards, storefronts). In one implementation, the web-based presentation 122 corresponds to an online or web-based presentation, such as provided on a web page or web page component. In one implementation, an organization may host a web page and include the presentation 122 as a dashboard on the page. Likewise, the embedded information 134 may include words, phrases or images that provide qualitative/quantitative information that is updated or recent, and based on the one or more values 112. For example, embedded information 134 may be carried in signature lines of emails, or on electronic documents supplied from the organization to customers or partners. Print presentations 136 may be supplied similarly. For example, the organization may carry information corresponding to presentation 122 on its annual shareholder meeting documents or company-filed paperwork.

Architecture

FIG. 2 illustrates a system architecture for enabling calculation and display of information that indicates an organization's conservation activities, according to an embodiment of the invention. A system 200 may include a parameter parser and/or tally component 210 (‘parser 210’), a ‘green’ (in reference to environmental goodness or conservation activities) module 220 and a web presentation 230. System 200 may be implemented on one or more computers or servers, such as within the domain or network properties of an organization. Alternatively, some or all of the system 200 may be implemented remotely to an organization that is using the system 200.

The parser 210 may interface with operators 212 or other individual's acting on behalf of the organization and/or programmatic activity monitors 214. The parser 210 may interface to identify instances of conservation activity. The green module 220 may access resources, such as information databases and libraries, to determine conservation quantities and waste reduction values. The web presentation 230 enables the organization to present its calculations stemming from its conservation activities.

In an embodiment, the parser 210 and green module 220 implement processes of the calculator 110 (see FIG. 1). Input, in the form of activity information 208 may be provided to parser 210. The activity information 208 may be supplied from human operators 206 and or programmatic monitors 207. In one embodiment, human operators 206 may be used to supply information that reflects choices the organization made that resulted in environmental conservation. As such, the activity information 208 may identify a single action in an activity class (e.g. a single instance of a member of the organization using file transfer service in lieu of a courier), or alternatively, a series of actions or activities that may be viewed collectively as part of one conservation activity decision of the organization. As with other examples, the organization's choices may include decisions to perform activities of a class that are designated as being conservation activities. According to an embodiment, these activities may be deemed conservation activities because they are presumed to replace a corresponding activity (i.e. one that achieves a similar result) that has a greater environmental impact. For example, the activity class may include activities that enable the organization to accomplish a desired result or goal, without need for physical transportation to take place. One embodiment provides for the activity class to include instances of when the organization uses a file transfer service to deliver large documents or files, as such file transfer services eliminate the need for the use of couriers such as postal mail or FEDERAL EXPRESS.

System 200 may be configured to accommodate numerous other types of environmental or conservation activities as well, such as, for example: (i) video conferencing activities, which may be presumed in at least some instances in eliminating the need to transport participants to a common location; (ii) enterprise network usages which facilitate or promote an organization's employees in telecommuting rather than traveling and being physically present on the premise of the organization. While numerous types of activities are contemplated, examples and specifics provided below focus on the activity of the organization using electronic document transfer services in lieu of couriers and transport of physical documents.

In an embodiment in which the class of activities correspond to use of electronic communications to avoid a corresponding physical transport, the input provided by the operators 206 may include one or more of (i) identifying the number of packages (e.g. boxes, envelopes, packaging material) that were not used as a result of the organization electing to use electronic transfer; (ii) identifying information about the receiving part, such as the geographic location of the receiving party; (iii) information that may affect difficulty of transport, such as the weight of the package that would have been sent, or the expediency required for the delivery. In other embodiments, similar information may be provided for other kinds of activities. For example, the operator 206 may enter information that identifies the commute or travel required by individuals who elect to video conference rather than meet in person.

According to an embodiment, activity information 208 may be determined programmatically, through, for example, interfaces that monitor usage of alternative ‘green’ services. In one embodiment, the activity monitor 207 interfaces with a file transfer service provider that enables advanced file transfer services for documents, and large files in particular. In one implementation, the activity monitor 207 may tally each instance of use for the file transfer service. Likewise, the activity monitor 208 may identify information about the location of the recipients, or make other determinations (e.g. size of package, expediency) to make a determination as to some or all of the activity information 208. In one embodiment, the activity monitor 207 may interface with electronic request resources of couriers (e.g. FEDERAL EXPRESS website) to ensure physical transport did not occur. For implementations that account for activities other than electronic file transfer, activity monitor 207 may monitor other relevant resources, such as the use of video conferencing services or VPN monitoring by individuals of the organization.

The parser 210 may use activity information 206 to determine activity parameters 212. The activity parameters may include one or more of (i) a tally of the number of times the conservation activity took place, (ii) a tally or count of resources (e.g. packages or envelopes) that were conserved as a result of the conservation activity having taken place, (iii) variables or parameters that affect the amount of conservation activity.

The green module 220 may quantify one or more green values 222 for the conservation activities of the organization, based at least in part on the activity parameters 212. Each green value may correspond to a quantification of an environmental concern, such as reduction in greenhouse gases or paper-products used. In determining the green values 222, the green module 220 may access one or more information resources 240 that enable it to correlate activity parameters 212 (such as tallies or other input) into conservation amounts. The information resources 240 may be external to system 200 (such as accessible over the Internet) or integrated within a domain or machine that implements system 200. In an embodiment, the information resources 240 may include greenhouse data store 244, which provides correlation data 245, formulas or other resources for converting one or more of the parameters 212 into greenhouse conservation quantities. In one embodiment, activity parameters 212 may map into one or more kinds of correlation data 245. In one implementation, the correlation data 245 may be in the form of a table that converts a tally of a particular activity into a conservation amount of carbon dioxide. As such, the greenhouse conservation quantities may represent quantities of greenhouse gases, such as carbon dioxide or other types of gases, by weight or other measurement. Other information resources may also be used. For example, when electronic file transfer activities are tallied, the location of the recipient may be recognized as affecting the amount of greenhouse gases that are conserved.

According to an embodiment, information resources 240 may include one or more geographic data stores 248 to enable calculations to account for the location of the recipient, or the affects of not having to use a courier service. For electronic file transfers in particular, an embodiment provides that the geographic data stores 248 can map electronic footprint information of a recipient, such as the recipient's Internet Service Provider's address or email domain, into a geographic proximity. In this way, the geographic data stores 248 may provide information which weights, affects or otherwise combines with the correlation data 245, in connection with data provided from the greenhouse data store 244.

The presenter 230 may generate a presentation 232 to include information or data that correlates or represents the green values 222. The presentation 232 may be in the form of a web page, or a dynamic portion of a web page (e.g. such as provided by a dashboard). In an embodiment, the green values 222 are provided on the presentation 232 in a manner that is human interpretable. For example, the presentation 232 may display information that shows the metric tons of carbon dioxide that the organization has conserved in a day or week as a result of its conservation activities. The presentation 232 may also display a tally of the number of envelopes or packages conserved. Depending on the implementation, correlation to trees saved (as well as greenhouse gases preserved from not utilizing trees) may also be displayed. As another additional or alternative, the green values 222 may be interpreted or used as qualitative or descriptive measures, such as “good” or “excellent”.

In one embodiment, archival resources 250 may be included or coupled for use with system 200 to archive or store historical information 252 about the organization's conservation activities. The historical information may correspond to, for example, past cumulative tallies of green values 222 as determined in a given duration (e.g. day or week), so that the organization may keep track of and even market its conservation activities.

Still further, an embodiment provides that the system 200 may be integrated or coupled with an online community 260. Members of the online community may view resources related to conservation activities, share information for improving or using conservation resources, or even exchange credits (e.g. ‘carbon credits’) with one another under a currency scheme. In one embodiment, system 200 and/or the standard that it implements is objective, and derived from a third-party as part of a service. The third-party may provide access to its resources through the community resources 260. The information resources 240, for example, may be maintained or shared with the community members. In an embodiment, the green module 220 of system 200 shares its green values 222 with the community resources 260. Input from the community resources 260 may also be received. For example, comparison information from other members of the community may be used or viewed from system 200.

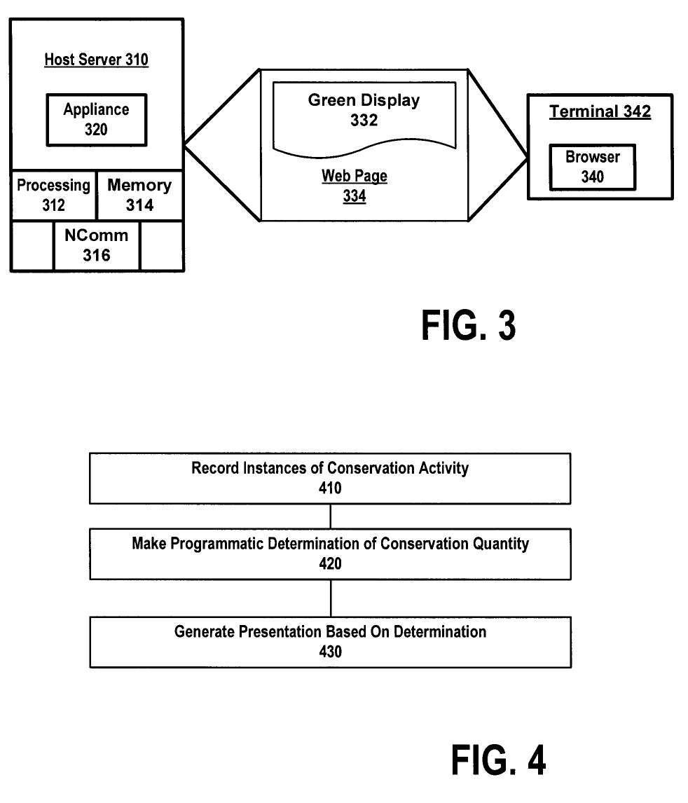

FIG. 3 illustrates a machine architecture for use with one or more embodiments described herein. A system such as described with an embodiment of FIG. 2 may be implemented through use of one or more host servers 310. The host servers 310 may implement a combination of hardware resources, including processing resources 312, memory resources 314 and network communication resources 316. The network communication resources 316 may enable, for example, web-site hosting, as well as programmatic resources such as provided by activity monitor 207 (see FIG. 2). The resources of the host servers 310 may also include components and interfaces to enable other functionality described herein, such as components or interfaces for enabling/communicating with activity monitor 207 (see FIG. 2) (e.g. interface to monitor third-party service for electronic file transfers or video conferencing) and human input interface for enabling input from the operators 206 (FIG. 2). In one implementation, the host servers 310 may belong to or be under control of the organization that is being monitored for its conservation activities. As an alternative or addition, server or machine resources for implementing a system such as described with an embodiment of FIG. 2 may be provided as part of a third-party service. The third-party service may be a multi-tenant server hosting service for use by corporations or other entities. Still further, the third-party service 310 may be dedicated for purposes such as described with embodiments of FIG. 1 and FIG. 2.

An appliance 320 may be used by the host server 310 for providing the functionality described with embodiments described herein. The appliance 320 may be virtual or physical depending on requirements or preferences of the host server 310. In one embodiment, the appliance 320 includes all the modules or components described with system 200 (FIG. 2), including some or all of the information resources 240.

According to an embodiment, the appliance 320 may be implemented to generate web-based content 332 on a web page 334. The web page 334 may be part of the organization's network properties. For example, the web page 334 may correspond to the home page of a corporation that subscribes to receiving functionality such as described by any of the embodiments described herein. The web content 332 may be dynamic, in that it may be updated continuously (e.g. at real-time or near real-time), or repeatedly, to display environmental benefits that result from the organization's activities. The display of environmental benefits may include values that quantify a particular environmental concern. Moreover, the information may be updated as activities are performed by the organization over the course of a duration (such as a business day).

According to an embodiment, some host server systems may employ multiple appliances. In one embodiment, each appliance may be dedicated for one organization that uses the host server system (e.g. such as a server hosting system).

Persons in the public, in the organization and/or partners or other individuals may view the page 334 through a browser 340 and terminal 342. In an embodiment, the web content 332 may display on the browser 340 when the person uses it to access the organization's website or network property. While an embodiment such as described uses a web-based medium to display results determined from the appliance 320, the appliance results may be implemented through numerous mechanisms and means, such as embedded data or information or on printed documents.

Methodology

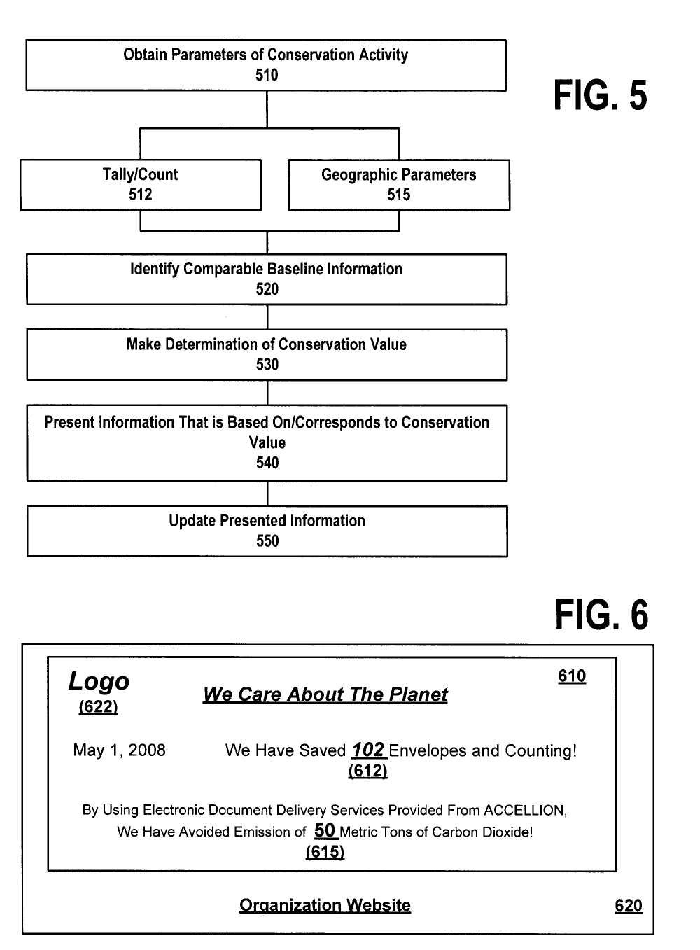

FIG. 4 and FIG. 5 illustrate computer-implemented methods for determining and presenting information about an organization's conservation activities, according to one or more embodiments. Methods such as described may be implemented using any of the modules or components described with other embodiments. As such, reference to elements of other figures is intended to illustrate a suitable component or element for performing a step or sub-step being described.

FIG. 4 illustrates a method by which an activity such as electronic file transfer or other communications may be used to determine conservation amounts or information, under an embodiment. In step 410, an embodiment provides that instances of a particular type of conservation activity are recorded. In one embodiment, the recorded instances correspond to instances in which the organization uses electronic file transfers of a particular type of kind (e.g. through a service). Still further, an embodiment provides that the recorded instances correspond to instances when the organization elects to use electronic file transfer instead of making a shipment to achieve a comparable result. For example, an organization may have the ability to use a shipment to deliver documents to a receiving party. But the organization may elect to use electronic file transfer to achieve a comparable result: the delivery of the same documents in electronic form to the same receiving party.

As another example, recording instances of the conservation activity may correspond to recording instances that the organization enabled video conferencing. Rather than requiring physical participation, the comparable result may be achieved through video conferencing. As such, an embodiment may record instances that the organization used video conferencing, on the assumption that the video conference was an election that avoided the need for the participants to meet physically.

Step 420 provides for making a programmatic determination of a quantity that is conserved as a result of the recorded instance of the conservation activity. In an embodiment, the quantity determination may be based on one or more of a tally of each instance or occurrence of the activity, a value associated with each occurrence, parameters that affect the values at one or more instances. According to one embodiment, each recorded instance of the conservation activity is correlated to a quantity or measure of carbon dioxide (or greenhouse gases) that would have been emitted had the non-conservation activity (e.g. shipment or physical conference participation) been performed to achieve the comparable result. Each instance of the conservation activity may be assumed to have the same carbon dioxide emission conservation amount, based on some gross average. Such an assumption may provide an objective basis for calculating the conserved quantity. Alternatively, parameters may affect the calculated conservation amount. For example, the parameters may correspond to situation-specific or customer specific parameter values.

Step 430 provides that a presentation is generated that is based on the quantity determination of the conservation amount. An example of such a presentation is illustrated with an embodiment of FIG. 6. For example, the presentation may correspond to a web-based “dashboard” that displays a tally of the number of packages conserved (or instances that the conservation activity occurred) as well as a cumulative total of the carbon dioxide emissions that are calculated as being conserved or avoided.

FIG. 5 illustrates a method for determining and presenting information that quantifies an environmental concern as a result of the organization using electronic communications to perform a class of activities, under an embodiment of the invention. In step 510, parameters and/or other information is obtained about conservation activities that are performed by the organization (e.g. by employees of a company). As described with other embodiments, the conservation activities may correspond to choices or policies that elect the conservation activity over another action. An embodiment provides that one or more parameters are obtained about a particular type of conservation activity, such as electronic file transfer services as substitution of courier services. The conservation activity may be performed by the organization to conserve or reduce a quantity of interest, such as carbon dioxide or other gases that are deemed to cause global warming. The parameters may be manually entered by operators who interface with, for example, system 200 (FIG. 2). As an alternative or addition, the parameters may be obtained programmatically, such as through use of the activity monitor 207, which may monitor an account that is associated with conservation activity (e.g. account for use of electronic file transfers). Still further, the parameters may be determined through intelligent analysis of information that is descriptive of activities that the organization undertook. For example, for the activity of electronic file transfer, parameters relating to identifying the receiving party, including the geographic location of the receiving party, may be determined through analysis of information presented with the online account or other resources.

Sub-steps that may be performed as part of step 510 may vary. In one embodiment, sub-step 512 provides that the obtained parameters include obtaining a tally or count. The tally or count may represent or correlate to the number of instances that a particular conservation activity took place, or to the number of resources conserved (e.g. envelopes) as a result of each instance of the conservation activity.

As an addition or alternative, sub-step 515 provides that the geographic parameters pertinent to the conservation activity are determined. This may include geographic or other relevant parameters of a corresponding activity that is avoided as a result of performing the conservation activity. In the case where the conservation activity corresponds to electronic file transfers, the pertinent geographic parameters may correspond to the locale of the receiving party, the separation of the receiving party and the sending party, and/or information that is indicative of the nature or type of alternative courier service that could have been used.

In an embodiment, step 520 provides that a baseline is determined or identified that represents the quantity of interest that would be expended in the event the organization elects to undertake the corresponding non-conservation activity. The baseline identification may correspond to the use of, for example, a table of data values containing the baseline information. In one implementation, the baseline information may quantify the waste that would otherwise result in the event the organization elects to perform the comparable non-conservation activity. For example, step 520 may provide for the determination of the amount of carbon dioxide that is expended as a result of the organization shipping (via courier) documents that could have otherwise been transferred electronically. Such baseline information may be tabulated or maintained as approximations or through objective standardization techniques. To further the example, each shipment may be assumed to expend x amounts of carbon dioxide. Alternatively, each shipment may be assumed to expend an amount of carbon dioxide that is dependent on the geographic separation of the sending and receiving parties.

In step 530, a determination is made as to the conservation amount of the quantity of interest. For example, the amount of carbon dioxide emissions that are avoided as a result of the organization electing to use electronic file transfers may be determined. The determination may be made through a comparison of the parameters or determinations made in step 510 and the baseline information obtained in step 520.

Step 540 provides that information is presented about the conservation amount of the quantity of interest. For example, the amount of carbon dioxide emissions that are avoided may be presented. As described with other embodiments, the information may be presented on or as part of a web page (such as described with an embodiment of FIG. 6).

According to an embodiment, step 550 provides that the information presented in step 540 is updated repeatedly, or continuously (e.g. in ‘real-time’ or near real-time) as additional information about the organization's conservation activities is learned. Thus, a method such as described with an embodiment of FIG. 5 may be ongoing, so as to be repeated to reflect, for example, each instance in a day or week that an organization elected to use electronic file transfer instead of couriers.

Presentation

An embodiment includes a computer-generated presentation that is provided on an online medium. The computer-generated presentation includes a sponsor component and one or more information items. The sponsor component displays information (e.g. such as a brand) that identifies an organization that is associated with the presentation. The computer generated presentation may also include one or more information items, including at least a displayed value that quantifies, based on a pre-defined standard or formulation, an environmental benefit that is achieved as a result of the sponsoring organization electing to use electronic communications as a substitute for physical transportation in performing a designated class of activities.

FIG. 6 illustrates a presentation that may be generated or configured, according to one or more embodiments described herein. According to an embodiment, a presentation 610 may be computer-generated presentation, provided on a website or other online medium. In one implementation, the presentation 610 is a dynamic element or component on a host web page 620. For example, presentation 610 may be provided as a dashboard element on an organization's website or web property. The host web page 620 may be, for example, an organization's home page, or the page dedicated to showing the conservation efforts of the organization. Accordingly, the presentation 610 may include a sponsorship component 622. The sponsorship component 622 may include a name or brand of the sponsoring organization (i.e. the organization that is performing the conservation activities). In this way, the presentation 610 may provide a marketing tool to enable the general public, customers and/or partners of the organization see the organization's efforts in improving an environmental concern. This may correspond to, for example, a reduction of carbon dioxide or other gases that are considered to cause or facilitate global warming effect.

The presentation 610 may show different kinds of information items. For example, under an embodiment, the information shown includes a display value that corresponds to a tally or count 612. In the example provided, the tally/count 612 corresponds to the number of envelopes or packages that the organization conserved as a result of the organization using electronic communications (such as file transfers) in lieu of physical transportation (shipping documents) when performing a particular class of activities (e.g. document or information sharing, multi-person conferencing). As another example, the tally or count element 612 may correspond to a count or tally of each instance in a given duration that the conservation activity of interest is performed by members or participants of the organization.

The information shown in the presentation 610 may also include another displayed value, corresponding to a derived amount 615. The derived amount 615 may also quantify an environmental concern, such as reduction in carbon dioxide emissions. In one implementation, the derived amount 615 may correspond to a product or other calculation that is based at least in part on the value of the tally amount. Still further, the derived amount 615 may correspond to an amount of the resource or quantity of interest that is conserved (or not wasted), such as savings in carbon dioxide emissions. For example, the derived amount 615 may reflect the amount of carbon dioxide (or other greenhouse gases) that were not emitted as a result of the organization electing to use electronic communications (e.g. electronic file transfer of information item or document) to communicate a particular content, rather than physical transportation (e.g. courier) to communicate the same contents to the identified recipients.

In an embodiment, the presentation 610 may reflect updated or even real-time information. Particularly, the tally/count element 612 and/or the derived amount 615 may each reflect updated values. For example, the values presented may reflect the organization's efforts from the previous day, week, or month. Alternatively, the presentation 610 may reflect the conservation activities performed by the organization in a given duration and up until a current moment in time.

In an embodiment, some or all of the elements in the presentation 610 may be selectable or otherwise activatable as links, so as to enable the presentation viewer (e.g. person of the public) to browse to an alternative network location. According to one embodiment, the presentation 610 may be selectable to cause the browser of the viewing terminal to access an online community where resources are provided to inform the user about conservation efforts and activities and/or about the particular conservation activity being performed by the organization.

Still further, as another alternative or addition, presentation 610 may provide supplemental content, in the form of a co-branding platform or advertisement medium. In one implementation, the supplemental content may relate or be generated on behalf of a party who provides, facilitates or enables the conservation activities. For example, presentation 610 may be co-branded with a name or logo of the party that provides a service for enabling the conservation activity (e.g. file transfer).

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A computer-implemented method for presenting information about an organization's waste reduction or resource preservation activities, the method comprising:
establishing baseline data that identifies or correlates to a quantity of a resource or waste associated with a physical transport of an item;
recording instances in which the organization elects to electronically transfer information as an alternative to physically transporting a corresponding item that carries the information on an alternative medium;
determining, based at least in part on the baseline data, a value that represents at least one of the resource preserved or the waste reduced as a result of the organization electing to electronically transfer information at the recorded instances; and
generating data for a presentation on an electronic medium that indicates the value of the at least one of the resource preserved or waste reduced.

2. The method of claim 1, wherein generating data for a presentation on an electronic medium includes generating a web-based presentation on a public online medium.

3. The method of claim 1,
wherein establishing the baseline data is based at least in part on data that corresponds to a determined amount of carbon dioxide emission that is deemed to result from the alternative of physically transporting the item;
wherein determining the value includes determining an amount of carbon dioxide emissions that are avoided by electronically transferring the information.

4. The method of claim 1, wherein determining the value representing at least one of the resource preserved or the waste reduced includes determining a value of packaging that is conserved by avoiding physical transport of the corresponding item.

5. The method of claim 3, wherein establishing the baseline data includes using information that estimates required fuel consumption for physically transporting the corresponding item from a geographic location of a source of the electronic transfer to a geographic location of a destination of the electronic transfer.

6. A computer-implemented method for presenting information about an organization's waste reduction or resource preservation activities, the method comprising:
recording data corresponding to one or more instances in which the organization elects to forego making a shipment to achieve a desired result in favor of using electronic communications to achieve a comparable result;
making a determination as to a quantity of a resource that is conserved by the organization using the electronic communications to achieve the comparable result;
generating a presentation on an electronic medium that includes information which indicates or is derived from the determination of the quantity of the resource that is conserved.

7. The method of claim 6, wherein recording one or more instances includes recording one or more instances in which the organization electronically transfers one or more files in favor of shipping information provided in the files a tangible medium.

8. The method of claim 6, wherein making a determination as to a quantity of a resource that is conserved includes determining a number of packages that are conserved by the organization foregoing making the shipment.

9. The method of claim 6, wherein making a determination as to a quantity of a resource that is conserved includes making a determination as to amount of fuel that is conserved by the organization foregoing making the shipment.

10. The method of claim 9, wherein the information that is derived from the determination includes information that is indicative of an amount of waste reduction that is associated with conservation of the number of packages, and wherein generating the presentation includes determining and presenting the information that is indicative of an amount of waste reduction.

11. The method of claim 6, wherein the amount of waste reduction identifies or correlates to an amount of greenhouse gases that are avoided as a result of the number of packages that are conserved.

12. The method of claim 6, further comprising linking the presentation to a website that is a sponsor or affiliate of a service that enables the electronic communications.

13. A computer-generated presentation provided on an online medium, the computer-generated presentation comprising:
a sponsor component that displays an organization that is associated with the presentation;
one or more information items, including at least a displayed value that quantifies, based on a pre-defined standard or formulation, an environmental benefit that is achieved as a result of the sponsoring organization electing to use electronic communications as a substitute for physical transportation in performing a designated class of activities.

14. The presentation of claim 13, wherein the displayed value is dynamic and indicative of an ongoing determination of the organization performing the designated class of activities in at least a given time period.

15. The presentation of claim 13, wherein the one or more information items include a second displayed value that represents a tally of an organizational resource that is being conserved as a result of the sponsor organization using the electronic communications in performing the class of activities.

16. The presentation of claim 15, wherein the tally of the organization resource corresponds to a count of envelopes or packages that are not used as a result of the sponsoring organization electing to use electronic communications to communicate a content to recipients in place of shipping items that contain the same content.

17. The presentation of claim 13, further comprising one or more links that, when activated by a browser operating on a terminal that accesses the presentation over the online medium, causes the browser to access another website of a sponsor.

18. The presentation of claim 13, wherein the displayed value quantifies a reduction of greenhouse gas that is achieved as a result of the organization performing the designated class of activities.

19. The presentation of claim 17, wherein the one or more links include a link to a community website that includes information that is shared by a plurality of organizations about the class of activities or a corresponding environmental concern.

20. A computer system for presenting information about waste reduction or resource preservation activities of one or more entities, the computer system comprising:
a server resource that is programmed to generate a presentation for an online medium, wherein the presentation provides at least a first information item that is indicative of a determination of a reduction by a given entity in either of an identified waste byproduct or a resource consumption,
wherein the reduction is a result of one or more kinds of a conservation activity that is performed by one or more individuals in the organization.

21. The computer system of claim 20, wherein the server resource is configured to provide the presentation dynamically, and to update the first information item repeatedly or continuously as a result of identifying or detecting one or more additional conservation activities that are performed within the organization.

22. The computer system of claim 20, wherein the given entity corresponds to an organization, and wherein the presentation is provided as part of a web page that is hosted or sponsored by the organization.

23. The computer system of claim 20, wherein the server resource is programmed to generate the presentation to include a second information item that is indicative of a quantity or count of a conserved resource by the given entity.

24. The computer system of claim 22, wherein the server resource corresponds to a virtual appliance that operates on or with a server that provides a site of the web page.

25. The computer system of claim 22, wherein the server resource corresponds to a physical appliance that operates on or with a server that provides a site of the web page.
